(19) United States
(12) Patent Application Publication
(10) Pub. No.: US 2014/0379594 A1
(43) Pub. Date: Dec. 25, 2014

(54) RECORDING AND MAINTAINING ACCEPTANCES OF LICENSES FOR USING COMPUTER PRODUCTS

(71) Applicant: CISCO Technology, Inc., San Jose, CA (US)

(72) Inventors: John ALONGI, San Jose, CA (US); Satish SISTA, San Jose, CA (US)

(21) Appl. No.: 13/924,583

(22) Filed: Jun. 23, 2013

(51) Int. Cl. G06Q 30/00

(52) U.S. Cl. CPC G06Q 30/0185
USPC 705/318

(57) ABSTRACT

Techniques are provided for generating license agreements specific to a computer product (e.g., software or hardware). In one example, vendor license manager receives an order from a customer for a computer product having a product identifier. Upon identifying an agreement corresponding to the product identifier, the license manager further embeds terms and conditions based on specifications of the customer order. After the customer reviews the agreement and accepts, the license manager associates the product-specific agreement, the acceptance, and the order to a logical customer account.

### TECHNICAL FIELD

The present disclosure relates generally to licensing computer software or hardware. More specifically, techniques are disclosed for generating license agreements for computer software or hardware products specific to each product.

### BACKGROUND

Generally, when an end-user customer purchases a computer product (e.g., software or hardware) from a vendor, the customer is required to accept the terms and conditions of a vendor license agreement before being able to use the product. These license agreements may be presented to the customer in several ways. For example, many software applications use “clickwrap” agreements as a form of license agreement. More specifically, when a customer installs a software application, an installation program of the application displays a “clickwrap” agreement to the customer through a graphical user interface, and the customer accepts the terms and conditions provided in the agreement by clicking on an “Accept” button located on the interface. Another example of a software license agreement may be a paper agreement that the customer signs physically and returns to the vendor.

Although some vendors sell many types of products belonging to different product families, the license agreements that the vendors use may be template-based and not specific to a product. Therefore, tracing an accepted agreement to a particular product or a purchase order when needed may be difficult. One way that vendors can manage customer license rights is through contract management databases. However, these databases generally only enable vendors to track the agreements by customer (e.g., by using a customer identifier associated with a license acceptance in the database). Having knowledge of only the customer, a vendor still might not be able to determine the product the customer purchased or the order through which the customer purchased the product. As a result, the vendor is unable to use contract management databases to determine the products or the orders associated with the agreements. This may be a problem in cases where the customer is using the computer product beyond the terms and conditions of the license agreement and the vendor needs to pursue legal means of action against the customer.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a conceptual diagram of the licensing relationship between a customer and a vendor, according to one embodiment.

FIG. 2 illustrates a block diagram of an example router product sold by the vendor, according to one embodiment.

FIG. 3 illustrates a conceptual diagram of the relationships between a license manager, customer accounts, and license agreements, according to one environment.

FIG. 4 illustrates a method of generating a product-specific license agreement and associating the agreement to a product, according to one embodiment.

FIG. 5 illustrates a block diagram of a vendor-side server computing system configured to manage license agreements, according to one embodiment.

### DESCRIPTION

### Overview

One embodiment described herein includes a method. This method generally includes receiving purchase information from a customer. The purchase information includes a product identifier and an order specification of one or more computer products purchased by the customer from a vendor. The method also includes identifying a license agreement corresponding to the product identifier. The method also includes customizing the license agreement based on the order specification and sending the license agreement to the customer. The customized license agreement provides a set of one or more entitlements for using the computer products. Upon receiving an acceptance of the license agreement from the customer, the license agreement and the set of entitlements are associated with a customer account.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### DESCRIPTION OF EXAMPLE EMBODIMENTS

Embodiments presented herein provide techniques for generating and maintaining license agreements for computer products (e.g., software and/or hardware). In one embodiment, a vendor license manager maintains a database that stores license agreements that are associated with specific computer products. Upon the license manager receiving an order or registration from a customer for a computer product, the license manager matches a product identifier provided by the order with a corresponding license agreement. The license manager embeds customized provisions in the agreement based on order specifications (e.g., time, place, use privileges, etc.) and sends the agreement to the customer for acceptance. Upon receiving acceptance from the customer, the vendor license manager associates the corresponding agreement, acceptance, and order to a customer account maintained by the license manager.

For example, the embodiments may be practiced in a computer product licensing model where a customer of a vendor enters into an agreement with the vendor. Under this model, a customer purchases computer products (e.g., computer software or hardware) and agrees to allow the vendor to track customer use of the individual computer products (e.g., by having the computer products send customer use information to a vendor-side license manager) to ensure that the use of each product conforms to the terms and conditions specified in the corresponding license agreements. To track customer use, the license manager device generates a customer account associated with the purchases, orders, and corresponding agreements as well as provisions license entitlements for each product.

Further, the embodiments may also be practiced in an N-tier channel environment. Continuing the previous example of the licensing model, a customer may purchase the computer products from a channel partner or distributor that is affiliated with the vendor. Likewise, when the customer registers the computer products with the vendor license manager, the license manager generates a product-specific agreement and associates the agreement with the product and the customer order made through the partner. As a result, all parties involved may trace the agreement to the product or order through a customer transaction history.

Advantageously, the embodiments presented herein enable vendors to embed specific terms and conditions to a license agreement for an individual computer product (or family of computer products) on demand. Because the resulting agreement associates with a particular product, order, and customer account, each of the parties involved (e.g., a customer, a vendor, or vendor partners) can easily trace an agreement back to view a time of order, order details, time of acceptance, identity of the accepting customer, etc.

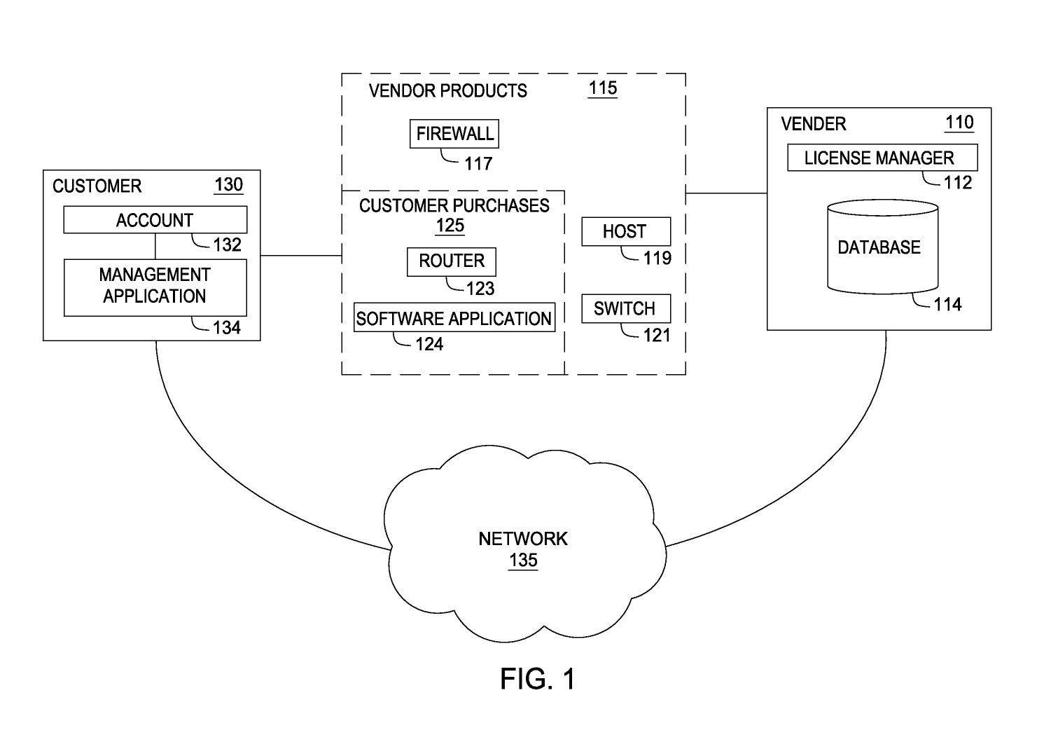

FIG. 1 illustrates a conceptual diagram of relationship between a vendor 110 and a customer 130 in the example licensing environment, according to one embodiment. As shown, vendor 110 has computer products 130 available for purchase. For example, computer products 130 may include a firewall 117, a host 119, a switch 121, a router 123, and/or a software application 124, among other products. A customer 110 who has entered the example licensing model (e.g., through an initial license agreement with vendor 110) purchases one or more computer products from vendor 110. In another embodiment, customer 110 may purchase products from a vendor-affiliated partner (not shown). In this example, the customer purchases 125 include a router 123 and a software application 124. Vendor 110 (or a partner of vendor 110) sends the products to customer 130.

Before using customer purchase 125, customer 110 activates the purchase through a license manager 112. License manager 112 may reside in a physical vendor server computing system or in a cloud server of the vendor. License manager 112 may be communicatively connected to a customer-side management application 134 (e.g., via a network 135). Customer management application 134 may provide an interface that displays license agreement information to customer 130. To activate computer purchase 125, customer 130, through customer management application 134, registers the product with license manager 112.

A registration of a purchase 125 may include an identifier or a product (or instance of the product). After license manager 112 receives purchase records and product registrations, license manager 112 generates a product-specific agreement and sends the agreement to customer 130 along with a request to accept the terms and conditions of the agreement (e.g., through a “click-to-accept” mechanism or other existing digital signature mechanism communicated to a user interface of customer management application 134). In generating a product-specific license agreement for a product, license manager 112 uses product specifications and order-specific agreements (e.g., time, place, entitlements, etc.) that are stored in a database 114 that license manager 112 then associates to a customer account 132.

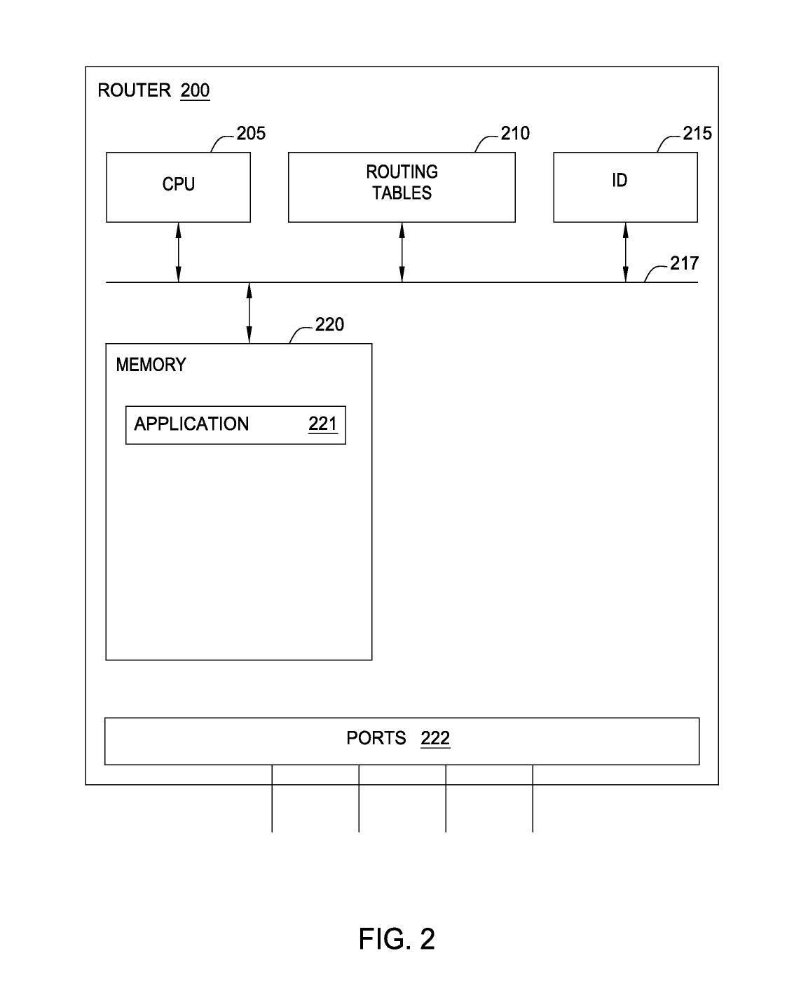

FIG. 2 illustrates a block diagram of an example router product 200 of the vendor, according to one embodiment. A customer may purchase router 200 and activate the router with the vendor. The vendor, during activation of router 200, may generate a license specific to the product and order specifications that the customer provides. In context of this description, the computing elements shown in router 200 correspond to hardware components and software modules (e.g., hardware and software in a datacenter).

As shown, router 200 includes, without limitation, a central processing unit (CPU) 205, an identifier 215, a memory 220, and ports 222, each connected to a bus 217. CPU 205 retrieves and executes programming instructions stored in memory 220, as well as stores and retrieves application data 342 and routing tables 210 residing in storage 240. Via bus 217, router 200 transmits programming instructions and application data 242 between CPU 205, identifier 215, memory 220, and ports 222. Note that CPU 205 is included to be representative of a single CPU, multiple CPUs, a single CPU having multiple processing cores, and the like. Memory 220 is included to be generally representative of a random access memory. Storage 240 may be a disk drive storage device.

On the vendor side, a license manager (e.g., residing on a memory of a server computing system on a vendor cloud network) communicates to router 200 via application 221. When a customer registers router 200, the license manager generates a product-specific agreement tied to identifier 215 (e.g., a product stock keeping unit, or a SKU) and the order specifications of the customer, effectively associating the agreement with router 200. In another embodiment, license manager may associate a particular agreement with a family of products. In yet another embodiment, if the customer configures router 200 prior to registering the product with the vendor license manager, then upon generation of the license agreement (upon registration), the license manager may further embed the pre-configurations into the terms and conditions of the license agreement. Further, application 221 may be configured to communicate with the license manager and act as a license enforcer for customer use. That is, application 221 periodically sends customer use information to the vendor license manager. If the license manager determines that the customer is currently using router 200 beyond the bounds of the license agreement, the license manager may notify application 221 of the non-compliance. Thereafter, application 221 may disable or limit features of router 200.

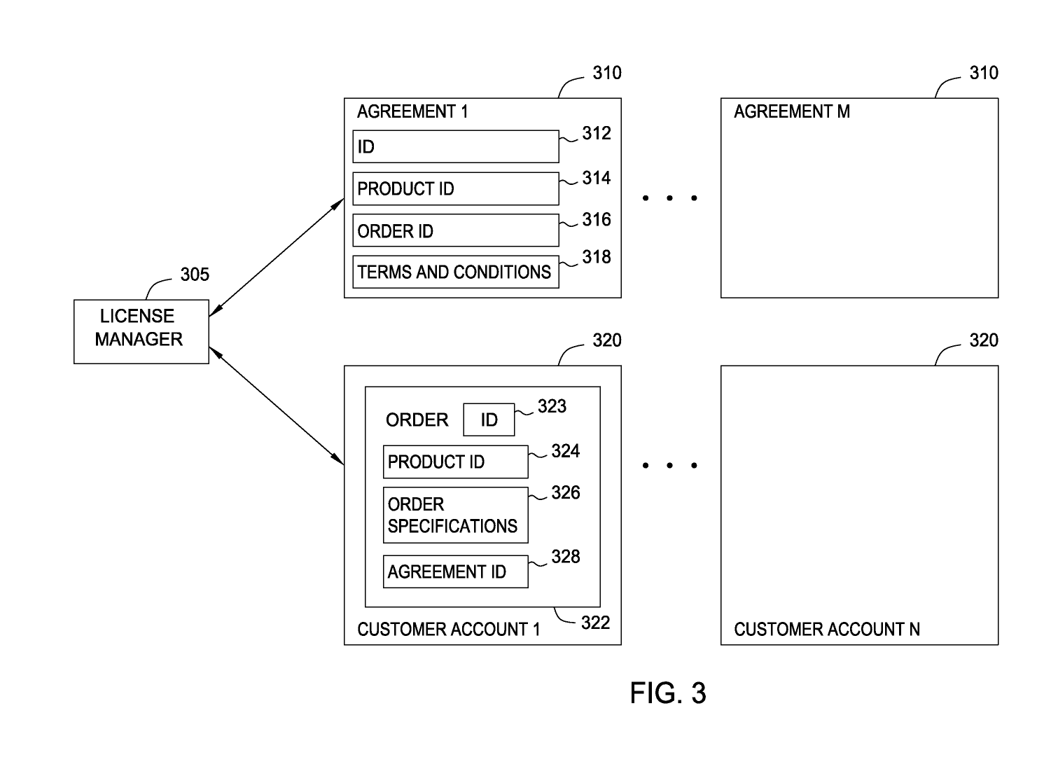

FIG. 3 illustrates a conceptual diagram of the relationships between a license manager 305, license agreements 310, and customer accounts 320 in the vendor-side of the example licensing model, according to one embodiment. License manager 305 serves as the backend for the example licensing model and communicates with a customer. As stated, license manager 305 is responsible for generating agreements 310 based on product specifics and customer orders. Further, license manager 305 ties this information to a customer account 320.

In one embodiment, license manager 305 may reside in memory of a server computing system in a vendor cloud network. A database on the residing on the same server computing system as license manager 305 (or on another server in the vendor cloud) stores one or more license agreements 310 and customer accounts 320.

A license agreement 310 may include an identifier 312, a product identifier 314, and terms and conditions 318. Prior to license manager 305 associating license agreement 310 to a particular customer account 320, a representative of the vendor, such as an administrator, creates terms and conditions 318 for license agreement 310 and ties the agreement to a specific product or product family using the product identifier 314. Thereafter, when the vendor receives an order from a customer for that particular product, license manager 310 accesses agreement 310 corresponding to the product identifier 314 to further customize terms and conditions 318 based on a set of order specifications 326. When a customer accepts terms and conditions 318 of a license agreement 310, license manager 305 associates the product ID 324 of order 320 as well as order 320 to the agreement 310. License manager 305 associates product identifier 324, order 320, and agreement 310 to customer account 320.

A customer account 320 may include one or more orders 322. Each order includes an identifier 323, one or more product identifiers 322 associated with the order, order specifications 326, and one or more agreement identifiers 328 associated with the order. License manager 305 embeds order details from order specifications 326 into terms and conditions 318. In one embodiment, terms and conditions 318 based on order specifications 326 may include user permissions (e.g., who can access the product), time duration (e.g., a start and end date for use), areas where the product can be used, maximum allowed instances, and so on.

In one embodiment, the terms and conditions may provide entitlements that license manager 305 provisions into a license pool associated with the customer account after a customer accepts license agreement 310. Once the customer accepts license agreement 310, the customer may begin consuming the entitlements by using the purchased product, and license manager 305, in turn, manages the customer's usage to ensure that the customer stays within the bounds of the entitlements. Additionally, license manager 305 may specify an overage for exceeding the license entitlements.

A license pool is a grouping of license entitlements and product instances. The license manager may store the agreed-upon license entitlements on a server located on a vendor cloud (i.e., in a network accessible repository). A license pool may be categorized by product line. For example, a license pool may correspond to a group of licenses for datacenter products, while another license pool may correspond to a group of licenses for telecommunications products. More generally, each license pool may relate to a common set of software products.

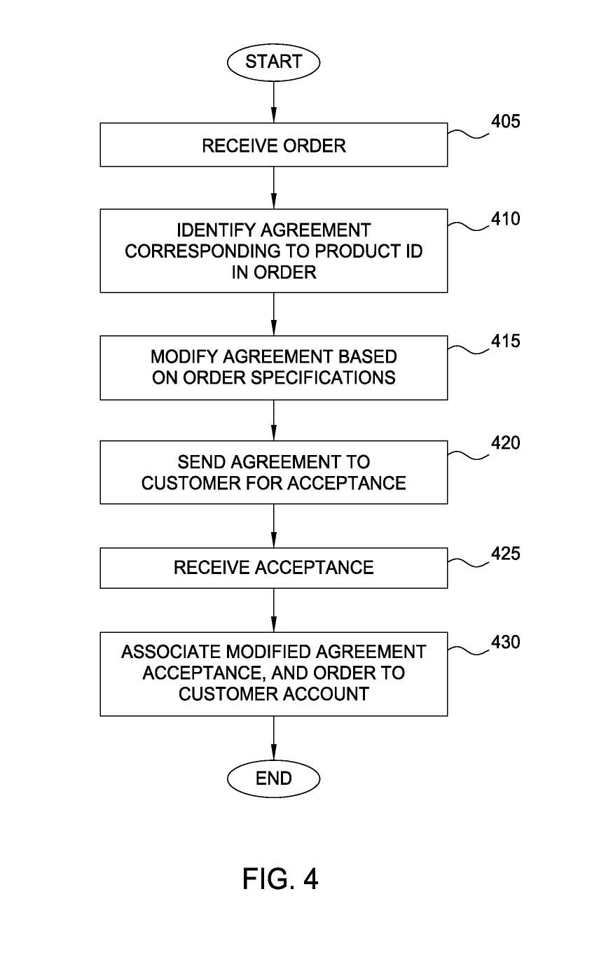

FIG. 4 illustrates a method 400 for generating a product-specific license agreement and associating the agreement to a product, according to one embodiment. Method 400 begins at step 405, where the vendor license manager receives an order from the customer. For example, assume a customer orders fifty software-based routers (i.e. virtual routers) from the vendor and begins to activate the routers through a customer management application.

At step 410, after receiving the purchase information and order specifics from the customer, the vendor license manager searches the database and identifies a license agreement that corresponds to the product identifier in the order. As stated, prior to receiving orders, the vendor may initially customize agreements for particular products and associate the agreements to a product before orders are received.

Upon identifying the product-specific agreement, the license manager modifies the agreement based on order specifications (at 415). The license manager modifies the license agreement based on order specifications. For instance, if the order specifies for fifty router instances to be run, the license manager includes agreement provisions entitling the customer to run the fifty instances. Additionally, the license manager may modify the agreement to include user permissions, time, place, and other provisions. For example, if a customer specifies in the order that for each router to be configured to have five open ports, the license manager may further customize the license agreement to include entitlement provisions based on the configuration. As another example, for some software products, a vendor might impose a limited usage duration. In this case, when the license manager receives the order, the license manager may create a start and end date and include the dates as provisions in the license agreement.

Additionally, the example licensing model may include allowance for overages, that is, the ability for the customer to exceed the bounds of the license entitlements. For instance, assume a license agreement provides an entitlement for fifty software instances of the virtual router. In the ongoing example, the customer might spawn ten additional instances after accepting the terms and conditions of the agreement, which exceeds the license entitlement. However, under the licensing model, the customer, in the order specifications, might request an amount of overage allowance. Alternatively, the vendor may provide such an allowance based on the product. In either case, the license manager may specify an overage for exceeding license entitlements and also specify an overage allowance in the agreement.

In an alternative embodiment, the license manager may account for a case where the customer configures the purchased computer product before registering the device. For example, if the customer pre-configures the virtual routers to have a certain number of open ports, then the license manager may modify the agreement based on the pre-configurations, in addition to the order specifications.

After modifying the agreement, the license manager sends the customized agreement to the customer and prompts the customer to review and accept the terms and conditions of the offer (at 420). The license manager can request acceptance by use of any existing digital signature technologies (e.g., through “clickwrap” agreement displayed to the customer through a graphical user interface). At step 420, the license manager receives acceptance from the customer.

At step 430, the license manager associates the customized license agreement, acceptance, and order details to the corresponding customer account. Doing this enables the license manager (as well as other parties to the transaction, such as the customer or a vendor partner selling the software directly to the customer) to trace the agreement to the specific product, such as the virtual router here, as well as the order. Tracing the agreement allows the parties involved to know the specific terms and conditions provided in the agreement, the order for which the agreement was created, and the customer who accepted the agreement.

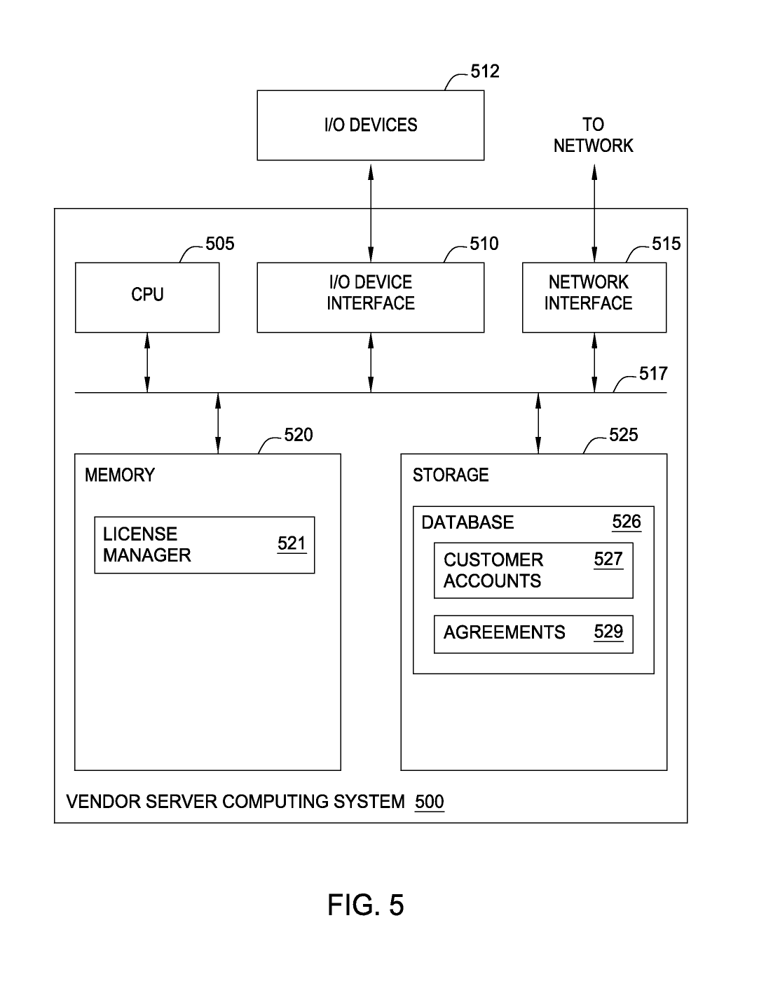

FIG. 5 illustrates a server computing system 500 of a vendor in the example licensing environment, according to one embodiment. As shown, server computing system 500 includes, without limitation, a central processing unit (CPU) 505, an I/O device interface 510, a network interface 515, a memory 520, and a storage 525, each connected to a bus 517. The I/O device interface 510 connects I/O devices 512 (e.g., keyboard, display, and mouse devices) to server computing system 500. Further, in context of this description, the computing elements shown in server computing system 500 may correspond to a physical computing system (e.g., a system in a data center) or may be a virtual computing instance executing within a cloud computing environment.

The CPU retrieves and executes programming instructions stored in memory 520 and stores and retrieves application data residing in storage 525. Via bus 517, server computing system 500 transmits programming instructions and application data between CPU 505, I/O devices 510, storage 525, network interface 515, and memory 520. Note that CPU 505 is included to be representative of a single CPU having multiple processing cores, and/or the like. Memory 520 is included to be generally representative of a random access memory. Storage 525 may be a disk drive storage device. Although shown as a single unit, storage 525 may be a combination of fixed and/or removable storage devices, such as fixed disc drives, removable memory cards, or optical storage, network attached storage (NAS), or a storage area network (SAN).

A license manager 521 resides in memory 520. Storage 525 includes a database having one or more customer accounts 527 and one or more agreements 529. License manager 521 communicates with computer products of a vendor as well as customer license management applications. For example, license manager 521 may send a request to a customer management application to accept terms and conditions of a license for a particular computer product order. License manager 521 is also responsible for associating agreements 529 with customer accounts 527 based on product specifications.

While the foregoing is directed to embodiments of the present disclosure, other and further embodiments of the disclosure may be devised without departing from the basic scope thereof. For example, aspects of the present disclosure may be implemented in hardware, software, or a combination of hardware and software. One embodiment of the disclosure may be implemented as a program product for use with a computer system. The program(s) of the program product define functions of the embodiments (including the methods described herein) and can be contained on a variety of computer-readable storage media. Illustrative non-transitory computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., a hard-disk drive or any type of solid-state random-access semiconductor memory) on which alterable information is stored. Such computer-readable storage media, when carrying computer-readable instructions that direct the functions of the present disclosure, are embodiments of the present disclosure.

Although embodiments of the present disclosure may achieve advantages over other possible solutions and/or over the prior art, whether or not a particular advantage is achieved by a given embodiment is not limiting of the present disclosure. Thus, the following aspects, features, embodiments and advantages are merely illustrative and are not considered elements or limitations of the appended claims except where explicitly recited in a claim(s).

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible or otherwise non-transitory medium that can contain, or store a program for use by or in connection with an instruction execution system, apparatus or device.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

Embodiments disclosed herein may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. A user can access any of the resources that reside in the cloud at any time, and from anywhere across the Internet.

In view of the foregoing, the scope of the present disclosure is determined by the claims that follow.

What is claimed is:

1. A computer-implemented method, comprising:
receiving, at a license manager module, purchase information from a customer, wherein the purchase information includes a product identifier and an order specification of one or more computer products purchased by the customer from a vendor;
identifying a license agreement corresponding to the product identifier;
customizing the license agreement based on the order specification, wherein the customized license agreement provides a set of one or more entitlements for using the computer products;
sending the license agreement to the customer; and
upon receiving an acceptance of the license agreement from the customer, associating the license agreement and the set of entitlements with a customer account.

2. The method of claim 1, wherein customizing the license agreement based on the order specification further comprises, specifying an overage for exceeding the set of entitlements in using the computer products.

3. The method of claim 1, wherein the set of entitlements are managed by the vendor via a network accessible repository.

4. The method of claim 3, further comprising, providing a partner associated with the customer with access to the set of entitlements in the network accessible repository.

5. The method of claim 1, wherein the order specification identifies a configuration for at least one of the computer products and wherein the license agreement is customized based on the identified configuration.

6. The method of claim 1, wherein each computer product periodically sends information to the vendor indicating customer use of the respective computer product, and further comprising, upon determining that the set of entitlements are insufficient to cover the received information, notifying a license enforcement module on the respective computer products of non-compliance.

7. The method of claim 1, wherein the order specification identifies the set of entitlements for at least one of the computer products by a product identifier.

8. A non-transitory computer-readable storage medium storing code for execution by a processor, wherein the code, when executed by a processor, performs an operation, the operation comprising:
receiving, at a license manager module, purchase information from a customer, wherein the purchase information includes a product identifier and an order specification of one or more computer products purchased by the customer from a vendor;
identifying a license agreement corresponding to the product identifier;
customizing the license agreement based on the order specification, wherein the customized license agreement provides a set of one or more entitlements for using the computer products;
sending the license agreement to the customer; and
upon receiving an acceptance of the license agreement from the customer, associating the license agreement and the set of entitlements with a customer account.

9. The computer-readable storage medium of claim 8, wherein customizing the license agreement based on the order specification further comprises, specifying an overage for exceeding the set of entitlements in using the computer products.

10. The computer-readable storage medium of claim 8, wherein the set of entitlements are managed by the vendor via a network accessible repository.

11. The computer-readable storage medium of claim 10, wherein the operation further comprises, providing a partner associated with the customer with access to the set of entitlements in the network accessible repository.

12. The computer-readable storage medium of claim 8, wherein the order specification identifies a configuration for at least one of the computer products and wherein the license agreement is customized based on the identified configuration.

13. The computer-readable storage medium of claim 8, wherein each computer product periodically sends information to the vendor indicating customer use of the respective computer product, and wherein the operation further comprises, upon determining that the set of entitlements are insufficient to cover the received information, notifying a license enforcement module on the respective computer products of non-compliance.

14. The computer-readable storage medium of claim 8, wherein the order specification identifies the set of entitlements for at least one of the computer products by a product identifier.

15. A system, comprising:
a processor; and
a memory hosting an application, which, when executed on the processor, performs an operation, the operation comprising:
receiving, at a license manager module, purchase information from a customer, wherein the purchase information includes a product identifier and an order specification of one or more computer products purchased by the customer from a vendor;
identifying a license agreement corresponding to the product identifier;
customizing the license agreement based on the order specification, wherein the customized license agreement provides a set of one or more entitlements for using the computer products;
sending the license agreement to the customer; and
upon receiving an acceptance of the license agreement from the customer, associating the license agreement and the set of entitlements with a customer account.

16. The system of claim 15, wherein customizing the license agreement based on the order specification further comprises, specifying an overage for exceeding the set of entitlements in using the computer products.

17. The system of claim 15, wherein the set of entitlements are managed by the vendor via a network accessible repository.

18. The system of claim 17, wherein the operation further comprises, providing a partner associated with the customer with access to the set of entitlements in the network accessible repository.

19. The system of claim 15, wherein the order specification identifies a configuration for at least one of the computer products and wherein the license agreement is customized based on the identified configuration.

20. The system of claim 15, wherein each computer product periodically sends information to the vendor indicating customer use of the respective computer product, and wherein the operation further comprises, upon determining that the set of entitlements are insufficient to cover the received information, notifying a license enforcement module on the respective computer products of non-compliance.

21. The system of claim 15, wherein the order specification identifies the set of entitlements for at least one of the computer products by a product identifier.
